(19) United States
(12) Patent Application Publication
(10) Pub. No.: US 2025/0147735 A1
(43) Pub. Date: May 8, 2025

(54) METHOD, APPARATUS, DEVICE AND STORAGE MEDIUM FOR MESSAGE PROCESSING

(71) Applicant: Beijing Zitiao Network Technology Co., Ltd., Beijing (CN)

(72) Inventors: Yiyu He, Beijing (CN); Jiangwen Wang, Beijing (CN); Zhong Wang, Beijing (CN); Qingyu Zhang, Beijing (CN)

(21) Appl. No.: 18/941,704

(22) Filed: Nov. 8, 2024

(30) Foreign Application Priority Data
Nov. 8, 2023 (CN) 202311485106.0
Nov. 22, 2023 (CN) 202311570265.0

(51) Int. Cl. G06F 8/30; H04L 51/02

(52) U.S. Cl. CPC G06F 8/31; H04L 51/02

(57) ABSTRACT

The embodiments of the disclosure provides methods, apparatuses, devices, and storage medium for message processing. The method includes: receiving, in an interaction between a user and a digital assistant, a conversation message of the user for the digital assistant; determining a processing result for the conversation message by a model, the processing result indicating target content matching a user requirement corresponding to the conversation message; and presenting, based on a first message presentation mode corresponding to an interaction channel in which the conversation message is received, a reply message of the digital assistant for the conversation message in the interaction channel, the reply message presenting at least a portion of the target content.

### CROSS-REFERENCE

This application claims priority to Chinese Patent Application No. 202311485106.0, filed on Nov. 8, 2023, and entitled “METHOD, APPARATUS, DEVICE, AND STORAGE MEDIUM FOR MESSAGE PROCESSING” and Chinese Patent Application No. 202311570265.0, filed on Nov. 22, 2023, and entitled “METHOD, APPARATUS, DEVICE, AND STORAGE MEDIUM FOR MESSAGE PROCESSING,” the entire contents of each of which are incorporated herein by reference.

### FIELD

Example embodiments of the present disclosure generally relate to the field of computers, and in particular, to a method, an apparatus, a device, and a computer-readable storage media for message processing.

### BACKGROUND

With the development of information technologies, various terminal devices may provide various services to people in aspects of work and life, etc. Applications providing a service may be deployed in the terminal device. The terminal device presents the corresponding content through a user interface of the application, realizes interaction with a user, and meets various types of requirements of the user. Therefore, a rich application interaction interface is an important means of improving user experience. The terminal device or application may provide functions such as a digital assistant to the user to assist the user in using the terminal device or application. How to provide services to the user in a way that matches the form of interaction between the user and the digital assistant is a technical problem to be explored currently.

### SUMMARY

In a first aspect of the present disclosure, a method for message processing is provided. The method comprises: receiving, in an interaction between a user and a digital assistant, a conversation message of the user for the digital assistant; determining a processing result for the conversation message by a model, the processing result indicating target content matching a user requirement corresponding to the conversation message; and presenting, based on a first message presentation mode corresponding to an interaction channel in which the conversation message is received, a reply message of the digital assistant for the conversation message in the interaction channel, the reply message presenting at least a portion of the target content.

In a second aspect of the present disclosure, an apparatus for message processing is provided. The apparatus comprises a message receiving module configured to receive, in an interaction between a user and a digital assistant, a conversation message of the user for the digital assistant; a result determining module configured to determine a processing result for the conversation message by a model, the processing result indicating target content matching a user requirement corresponding to the conversation message; and a message presentation module configured to present, based on a first message presentation mode corresponding to an interaction channel in which the conversation message is received, a reply message of the digital assistant for the conversation message in the interaction channel, the reply message presenting at least a portion of the target content.

In a third aspect of the present disclosure, an electronic device is provided. The electronic device comprises at least one processing unit; and at least one memory coupled to the at least one processing unit and storing instructions for execution by the at least one processing unit. The instructions, when executed by the at least one processing unit, cause the electronic device to perform the method of the first aspect.

In a fourth aspect of the present disclosure, a computer-readable storage medium is provided. The medium has a computer program stored thereon, and the computer program, when executed by a processor, implements the method of the first aspect.

It should be understood that the content described in this section is not intended to limit the key features or important features of the embodiments of the present disclosure, nor is it intended to limit the scope of the present disclosure. Other features of the present disclosure will become apparent from the following description.

### BRIEF DESCRIPTION OF DRAWINGS

The above and other features, advantages, and aspects of various embodiments of the present disclosure will become more apparent from the following detailed description in conjunction with the accompanying drawings. In the drawings, the same or similar reference signs refer to the same or similar elements, in which:

FIG. 1 illustrates a schematic diagram of an example environment in which embodiments of the present disclosure can be implemented;

FIG. 2 illustrates a schematic diagram of a hierarchical architecture for processing a message according to some embodiments of the present disclosure;

FIG. 3 illustrates an example process of converting a markup language into a card language according to some embodiments of the present disclosure;

FIG. 4 illustrates a flowchart of a process for message processing according to some embodiments of the present disclosure;

FIG. 5 illustrates a schematic structural block diagram of an apparatus for message processing according to some embodiments of the present disclosure; and

FIG. 6 illustrates a block diagram of an electronic device in which one or more embodiments of the present disclosure may be implemented.

### DETAILED DESCRIPTION

The embodiments of the present disclosure will be described in more detail below with reference to the accompanying drawings. Although some embodiments of the present disclosure are illustrated in the drawings, it should be understood that the present disclosure can be implemented in various forms and should not be construed as being limited to the embodiments set forth herein. Rather, these embodiments are provided for a more thorough and complete understanding of the present disclosure. It should be understood that the drawings and the embodiments of the present disclosure are provided for illustrative purposes only and are not intended to limit the scope of protection of the present disclosure.

In the description of the embodiments of the present disclosure, the term “including” and the like should be understood as non-exclusive inclusion, that is, “including but not limited to”. The term “based on” should be understood as “based at least in part on.” The term “an embodiment” or “the embodiment” should be understood as “at least one embodiment”. The term “some embodiments” should be understood as “at least some of the embodiments”. Other explicit and implicit definitions may also be included below.

Herein, unless explicitly stated, “in response to A” performing a step is not intended that this step is performed immediately after “A”, but may include one or more intermediate steps.

It is to be understood that the data involved in the technical solution, including but not limited to the data itself, the obtaining, usage, storage or deletion of the data, should comply with the requirements of corresponding laws and regulations and relevant provisions.

It is to be understood that, before using the technical solutions disclosed in the various embodiments of the present disclosure, the related user shall be informed of the type, the scope of use, and use scenarios and so on of information involved in the present disclosure in an appropriate manner in accordance with relevant laws and regulations, and the related user's authorization shall be obtained. The related user may include any type of subject of rights, e.g. individuals, enterprises, organizations.

For example, in response to receiving an active request from a user, prompt information is sent to the related user to explicitly prompt the related user that an operation requested by the related user will require to obtain and use information of the related user, so that the related user can autonomously select, according to the prompt information, whether to provide the information to software or hardware, such as an electronic device, an application program, a server, or a storage medium that performs the operations of the technical solutions of the present disclosure.

As an optional but non-limiting implementation, in response to receiving an active request of the user, the prompt information is sent to the user, for example, in the form of a pop-up window, in which the prompt information may be presented in the form of text. In addition, the pop-up window may further carry a selection control for the user to select “agree” or “not agree” to provide the personal information to the electronic device.

It should be understood that the above process for notifying and obtaining the user's authorization is merely illustrative, and do not limit the implementations of the present disclosure, and other approaches that meet the relevant laws and regulations may also be applied to the implementations of the present disclosure. In the embodiments of the present disclosure, enabling of the functions related to the digital assistant, the acquired data, the processing and storing modes of data, and the like shall all be authorized in advance by the user and other subjects of rights associated with the user, and shall comply with related laws and regulations and protocol rules agreed among the subject of rights.

As used herein, the term “model” may learn an association relationship between respective inputs and outputs from training data such that a corresponding output may be generated for a given input after training is done. Generation of the model may be based on machine learning techniques. Deep learning is a machine learning algorithm that processes inputs and provides corresponding outputs by using multiple layers of processing units. Neural network model is an example of the model based on deep learning. As used herein, the “model” may also be referred to as a “machine learning model,” “learning model,” “machine learning network,” or “learning network,” and these terms may be used interchangeably herein.

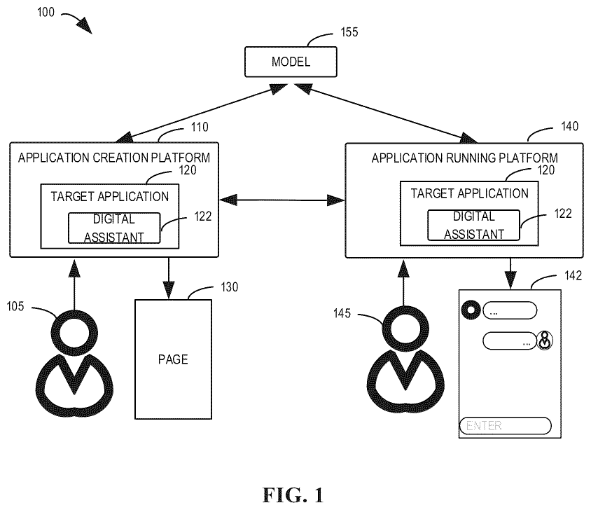

FIG. 1 illustrates a schematic diagram of an example environment 100 in which embodiments of the present disclosure can be implemented. The environment 100 relates to an application creation platform 110 and an application running platform 140.

As shown in FIG. 1, the application creation platform 110 may provide the user 105 with an application creation and publishing environment. The user 105 may be referred to as an application creation user, creator. In some embodiments, the application creation platform 110 may be a low code platform that provides a set of tools for application creation. The application creation platform 110 may support visual development of various applications, so that the developer may skip the manual coding process, accelerate the development cycle and reduce the cost of the application. The application creation platform 110 may support any suitable platform for a user to develop one or more types of applications, for example, may include an Application-Platform-as-a-Service (aPaaS) based platform. Such a platform can support efficient development of applications by users, and implement operations, such as application creation, application function adjustment, etc.

The application creation platform 110 may be deployed locally on the terminal device of the user 105 and/or may be supported by the server device. For example, the terminal device of the user 105 may run a client of the application creation platform 110, and the client may support interaction between the user and the application creation platform 110 provided by the server. In case the application creation platform 110 runs locally on the user's terminal device, the user 105 may directly interact with the local application creation platform 110 by using the terminal device. In case the application creation platform 110 runs on the server device, the server device may provide service to the client running in the terminal device based on the communication connection with the terminal device. The application creation platform 110 may present a respective page 130 to the user 105 based on the operation of the user 105 to output, to the user 105, and/or receive, from the user 105, information related to the application creation.

In some embodiments, the application creation platform 110 may be associated to a respective database, wherein the data or information needed by the application creation process supported by the application creation platform 110 is stored. For example, the database may store code and description information, etc. corresponding to each functional module for constituting the application. The application creation platform 110 may also perform operations such as invoking, adding, deleting, updating, and the like on functional modules in the database. The database may also store operations that may be performed on different functional blocks. For example, in a scenario in which an application is to be created, the application creation platform 110 may invoke, from a database, a corresponding functional block to build the application.

In the embodiments of the present disclosure, the user 105 may create a target application 120 on the application creation platform 110 as needed, and publish the target application 120. The target application 120 may be published to any suitable application running platform 140 as long as the application running platform 140 is able to support the running of the target application 120. After publication, the target application 120 may be used by one or more users 145 for operation. The user 145 may be referred to as a terminal user of the target application 120. In some embodiments, the target application 120 may include or be implemented as a digital assistant 122.

The digital assistant 122 may be configured to have an intelligent session. In the example shown in FIG. 1, the digital assistant 122 may be integrated into the target application 120 as a part of the target application 120 to assist in performing task processing within the target application 120. In other examples, the digital assistant 122 may be configured as an application that runs independently, such as a web application or other types of application. In such an example, the digital assistant 122 and the target application 120 may be considered as the same application. The digital assistant 122 is provided to assist the user in various types of task processing requirements in different applications and scenarios. During interaction with the digital assistant 122, the user inputs an interaction message and in response to the user input, the digital assistant 122 provides a reply message. Generally, the digital assistant 122 can support users to input questions in natural language and perform tasks and provide replies based on understanding of natural language input and logical reasoning capabilities.

In some embodiments, digital assistant 122 may interact with the user as a contact of user 145. For example, the digital assistant 122 may be implemented in an instant messaging (IM) application. The digital assistant 122 may interact with the user 145 in a single-chat session with the user 145. In some embodiments, the digital assistant 122 may interact with multiple users in a group-chat session that comprises multiple users.

For each user 145, the client of the application running platform 140 may present, in a client interface, an interaction window 142 of the target application 120 or the digital assistant 122, such as a session window with the digital assistant 122. User 145 may input a session message in the session window, and target application 120 may determine a reply message of digital assistant 122 based on created configuration information and present it to the user in the interaction window 142. In some embodiments, the interaction message with the target application 120 may include a multimodal form of messages, such as a text message (e.g., natural language text), a voice message, an image message, a video message, etc., depending on the configuration of the target application 120.

Similar to the application creation platform 110, the application running platform 140 may be deployed locally on the terminal device of each user 145, and/or may be supported by the server device. For example, the terminal device of the user 145 may run a client of the application running platform 140, and the client may support interaction between the user and the application running platform 140 provided by the server. In case the application running platform 140 runs locally on the user's terminal device, the user 145 may directly interact with the local application running platform 140 by using the terminal device. In case the application running platform 140 runs on the server device, the server device may provide service to the client running in the terminal device based on the communication connection with the terminal device. The application running platform 140 may present a corresponding application page to user 145 based on the operation of user 145 to output, to the user 145, and/or receive, from the user 145, information related to application usage.

In some embodiments, implementation of at least partial function of the target application 120, and/or implementation of at least partial function of the digital assistant 122 in the target application 120 may be based on a model. In the creation or running process of the target application 120, one or more models 155 may be invoked, for example, the capability of the model 55. In the target application 120, the digital assistant 122 may utilize the model 155 to understand the user input and provide a reply to the user based on an output of the model 155.

In the creation process, test of the target application 120 by the application creation platform 110 needs to utilize model 155 to determine that the running result of the target application 120 meets expectations. In the running process, in response to different operating requests of the user of the target application 120, the application running platform 140 may need to utilize model 155 to determine a response result to the user.

Although shown as separated from the application creation platform 110 and the application running platform 140, the one or more models 155 may run on the application creation platform 110 and/or the application running platform 140, or other remote servers. In some embodiments, the model 155 may be a machine learning model, a deep learning model, a learning model, a neural network, or the like. In some embodiments, the model may be based on a language model (LM). The language model can have question-answer capability by learning from a large amount of corpus. The model 155 may also be based on other suitable models.

The application creation platform 110 and/or the application running platform 140 may run on appropriate electronic devices. The electronic device herein may be any type of device having computing capability, comprising a terminal device or a server device. The terminal device may be any type of mobile terminal, fixed terminal, or portable terminal, comprising a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a pointing device, a television receiver, a radio broadcast receiver, an e-book device, a gaming device, or any combination of the foregoing, comprising accessories and peripherals of these devices, or any combination thereof. The server device may include, for example, a computing system/server, such as a mainframe, an edge computing node, a computing device in a cloud environment, or the like. In some embodiments, the application creation platform 110 and/or the application running platform 140 may be implemented based on cloud services.

It should be understood that the structure and function of the environment 100 are described for illustrative purposes only and do not imply any limitation to the scope of the present disclosure. For example, while FIG. 1 shows a single user interacting with the application creation platform 110 and a single user interacting with the application running platform 140, in practice multiple users may access the application creation platform 110 to each create a digital assistant, and each digital assistant may be used to interact with multiple users.

Conventionally, in the case that a digital assistant utilizes a machine learning model to provide a reply to a user conversation message, it does not differentiate between the interaction channels through which the user is interacting with the digital assistant. In this case, the content provided by the machine learning model does not differentiate between the interaction channels, and the content is not presented to the user in a form suitable for the interaction channel. This results in an impaired interaction experience with the digital assistant through different interaction channels.

On the other hand, if the content provided by the machine learning model is expected to be adapted for different interaction channels, the machine learning model is required to learn the content presentation modes of different interaction channels. This would cause the machine learning model unable to focus on content generation.

To this end, the embodiments according to the present disclosure provide a solution for message processing. According to various embodiments of the present disclosure, in an interaction between a user and a digital assistant, a conversation message of a user for the digital assistant is received. A processing result for the conversation message is determined by the model, and the processing result indicates the target content that matches the user requirement corresponding to the conversation message. A reply message of the digital assistant for the conversation message is presented in the interaction channel based on a message presentation mode corresponding to the interaction channel in which the conversation message is received, and the reply message presents at least a portion of the target content.

In various embodiments of the present disclosure, instead of having to learn and consider message presentation modes of different interaction channels, the model can focus on providing content that matches the user requirements. In this way, the user can be provided with accurate content that meets the user requirement, and the presentation mode of the content adapts to the interaction channel used by the user. Therefore, the interaction experience of the user and the digital assistant can be improved.

Example embodiments of the present disclosure are described below with continued reference to the accompanying drawings. For discussion purposes, the following examples are described from the perspective of an application running platform, for example, the application running platform 140 as shown in FIG. 1. The user interface presented by the application running platform 140 may be presented via a terminal device of the user 145, and the user input may be received via the terminal device of the user 145.

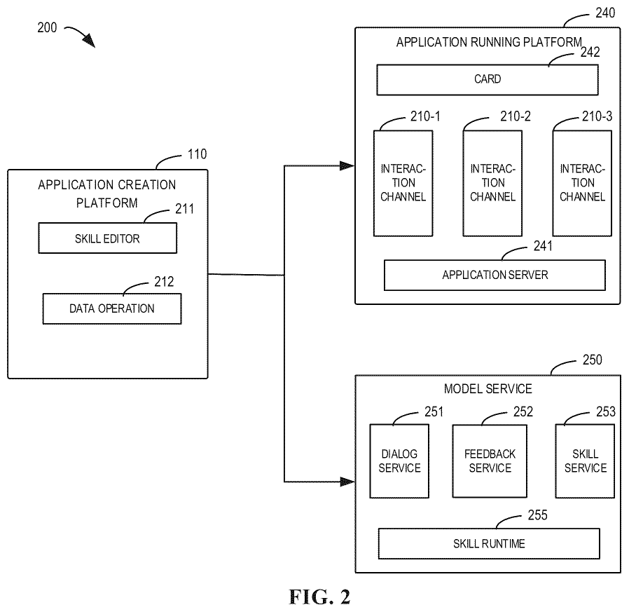

FIG. 2 illustrates a schematic diagram of a hierarchical architecture 200 for processing a message according to some embodiments of the present disclosure. As shown in FIG. 2, the application creation platform 110 may be deployed with a skill editor 211, and may implement various suitable types of data operations 212, such as data analysis functions, data update functions, and knowledge question and answering functions. Thus, the digital assistant may be created by the application creation platform 110. The digital assistant may provide services to the user 145 by the data operation 212.

The application running platform 240 may include an application server 241 to support functions of applications and/or digital assistant. The application running platform 240 may provide and support different interaction channels between the user and the digital assistant, such as interaction channels 210-1, 210-2, 210-3, which are also collectively or individually referred to as interaction channel 210. It should be understood that the number of interaction channels shown in FIG. 2 is merely illustrative and is not intended to limit the scope of the present disclosure. The application running platform 240 may be considered as an example implementation of the application running platform 140.

In some embodiments, the digital assistant can be triggered for interaction in a plurality of interaction channels. These interaction channels have respective message presentation modes and support respective computer languages. In some embodiments, the respective message presentation modes of the interaction channels may be based on respective conversational user interface (CUI) capabilities of the interaction channels.

The interaction channel may refer to an interaction form, an interaction mode, or an interaction interface between the user and the digital assistant. For example, the interaction channel may be an interaction via an IM application or component, and in such interaction, interaction messages between the user and the digital assistant are typically presented in message form. As another example, the interaction channel may be an interaction via a web interface, and in such interaction, interaction messages between the user and the digital assistant may be supported to be presented in rich media form. For still another example, for interaction via IM application or component, there may be different interaction channels, for example, one interaction channel supports a text type of interaction message, and another channel may support a card form of message. The card form of message may not only present text but also other forms of content, such as charts, forms, controls, and the like.

In the interaction between the user and the digital assistant, the application running platform 240 may receive the conversation message of the user for the digital assistant. The conversation message may be received through any interaction channel 210 and may correspond to a user requirement. For example, the user may ask a question to the digital assistant in a conversation window of an IM application. As another example, the user may ask a question to the digital assistant in a web page via a web interface.

To provide a reply to the user, the application running platform 240 may determine a processing result for the conversation message by a model 155. The processing result indicates target content matching the user requirement. For example, the conversation message may indicate data analysis on one or more data tables, and correspondingly, the target content indicated by the processing result may be a result of the data analysis.

By way of example, the application running platform 240 may generate a prompt word based on the conversation message of the user, and send the prompt word to the model service 250. The model service 250 may invoke any suitable model, such as the model 155. The model service 250 may include a dialog service 251, a feedback service 252, a skill service 253, and a skill runtime 255. Accordingly, the model service 250 may utilize one or more of these components to generate the processing result. It should be understood that FIG. 2 is merely illustrative. Although the model service 250 is shown separately from the application running platform 240, it should be understood that in some embodiments, the model service 250 may be part of the application running platform 240.

In the embodiments of the present disclosure, the generated processing result may indicate the target content and an overall presentation form of the target content, without a need to indicate a specific presentation style. For example, the processing result may indicate that the data is presented in a chart form without the need to indicate a particular style of the chart form, such as row and column widths, shading, font, and the like.

After receiving the processing result from the model service 250, the application running platform 240 (e.g., the application server 241) may convert the processing result into a message presentation style corresponding to the interaction channel in which the conversation message is received. In some embodiments, to present the reply message, the application running platform 240 may determine, from the plurality of interaction channels, the interaction channel in which the conversation message is received. Then, the reply message may be presented based on the message presentation mode corresponding to the interaction channel. For example, if the interaction channel supports only text, the presented reply message presents the target content in the form of text. As another example, if the interaction channel supports a graph, the presented reply message may present the target content in the form of graph. Further, specific presentation styles may be different for different interaction channels.

In some embodiments, the interaction channel in which the conversation message is received may support a first computer language, such as a first domain specific language (DSL), while the processing result may be represented in a second computer language, such as a second DSL. In this case, the processing result may be converted from the second computer language to description information in the first computer language. The reply message may then be presented based on the description information. Different interaction channels may support the same or different computer languages. Regardless of the computer languages supported by these interaction channels, the model 155 may return the processing result in the second computer language without adapting to or considering differentiations between different computer languages.

In some embodiments, the model 155 may be trained based on the second computer language. By way of example, the training of the model 155 may include prompt learning. For example, information associated with the second computer language may be added to the prompt words, and inputted together to the model 155. This enables the model 155 to generate feedback based on the second computer language. That is, the model 155 does not need to consider the differences in message presentation styles for different interaction channels, but may utilize a general language. Namely, the model may focus on the generation of content.

The second computer language utilized by the model 155 may be any suitable machine-readable language. In some embodiments, the second computer language may be a markup language.

In such embodiments, through the hierarchical architecture design (for example, an approach where the second computer language is fed by the model, and then the first computer language is configured according to the interaction channel in which the conversation message is received), differentiated presentation of the content output by the model is differentiated between the interaction channels (for example, the source of the conversation message). Thus, the presentation form supported by the end user is better adapted.

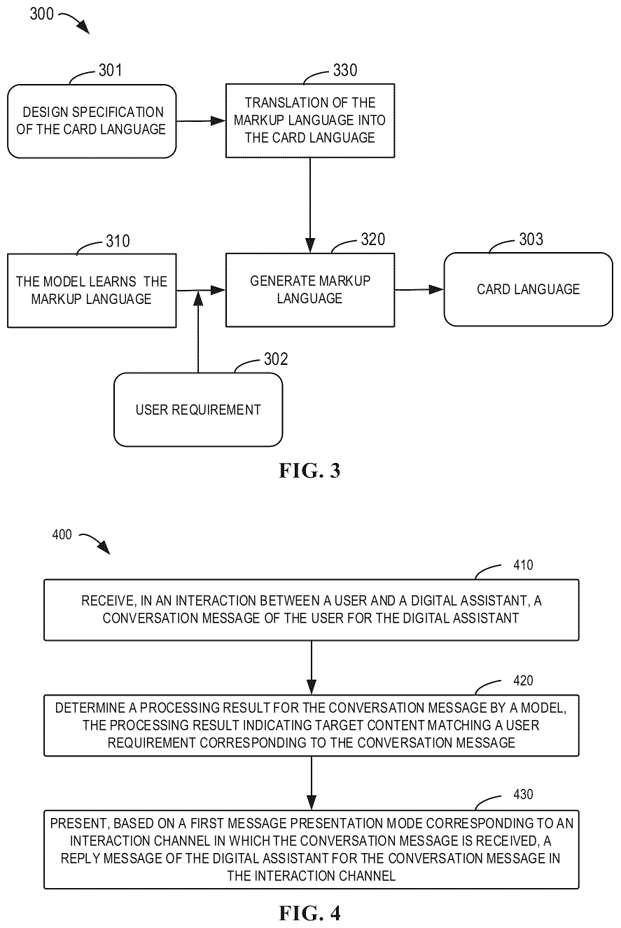

Some interaction channels may support the presentation of a reply message of the digital assistant to the user in the form of a rich-interaction message carrying manner (e.g., a message card). Conventionally, if a message card is required, it is necessary to assemble the JavaScript Object Notation (JSON) of the card according to the development protocol of the card. Because JSON involves both data and style, it becomes more difficult for the machine learning model to generate the card JSON directly or to control the style. To this end, in some embodiments of the present disclosure, for a card message, a computer language, also referred to as a card language, that the model is easy to understand and learn may be designed. FIG. 3 illustrates an example architecture 300 for converting between a card language and a markup language of a model.

The architecture 300 may include a design specification 301 of the card language, which may specify a presentation style of the card message. The presentation style may define various elements in the card and their styles, such as size, color, and so on. For example, for a chart, the design specification 301 may indicate a style related to a column, such as a column width, an alignment manner, a text font of a header, a shading of a header, and the like. The design specification 301 may also indicate a style related to the row, such as a line width, a text font of a header, a shading of a header, and the like.

At block 310, the model may learn the markup language. The learning of the markup language by the model may be prompt learning, as described above with reference to FIG. 2, or may be supervised learning, or the like. Embodiments of the present disclosure are not limited in this respect. Then, for example, the model service may generate a markup language 320 that matches the user requirement 302. The user requirement 302 corresponds to the conversation message from the user 145. In turn, at block 330, the application running platform 240 (e.g., the application server 241) may convert the markup language 320 into the card language 303 according to the design specification 301. The application running platform 240 may then render the message card according to the card language 303.

In some embodiments, the message card may support presentation of content in the form of data statistics, such as charts, sheets, and the like. Accordingly, the card language may describe a presentation style of content in the form of data statistics. For example, the card language may describe the layout and attributes of the chart, and/or the attributes (e.g., color, size), etc. of various elements (e.g., histogram, pie chart, line chart) of a chart.

The message presentation modes supported by the interaction channels may include a presentation style predefined for the form of data statistics, such as presentation styles for the chart and the sheet. In this way, the application running platform 240 may convert the markup language returned by the model into the card language according to the presentation style, and render the content described by the card language at the client device accordingly.

In some embodiments, such a predefined presentation style may also correspond to a type of the client device. For example, the presentation style corresponding to a mobile client may not be used for the presentation style corresponding to the personal computer (PC) end. That is, in such embodiments, the particular styles of the presented message cards may be different for the case from the same interaction channel but different types of client devices.

In such embodiments, the message may be presented to the end user flexibly according to the interaction. At the same time, this flexible presentation mode does not bring additional load to the model. This also facilitates the model to focus on content generation to provide more accurate results to the user.

FIG. 4 illustrates a flowchart of a process 400 for message processing according to some embodiments of the present disclosure. The process 400 may be implemented at an application running platform 140. The process 400 is described below with reference to FIG. 1.

At block 410, the application running platform 140 receives, in an interaction between a user and a digital assistant, a conversation message of the user for the digital assistant.

At block 420, the application running platform 140 determines a processing result for the conversation message by a model, the processing result indicating target content matching a user requirement corresponding to the conversation message.

At block 430, the application running platform 140 presents, based on a first message presentation mode corresponding to an interaction channel in which the conversation message is received, a reply message of the digital assistant for the conversation message in the interaction channel, the reply message presenting at least a portion of the target content.

In some embodiments, the processing result is represented in a second computer language, and wherein presenting the reply message for the digital assistant for the conversation message comprises: determining a first computer language supported by the interaction channel based on the first message presentation mode; converting the processing result from the second computer language to description information in the first computer language; and presenting the reply message based on the description information.

In some embodiments, the model is trained based on the second computer language.

In some embodiments, the second computer language includes a markup language.

In some embodiments, the digital assistant is capable of being triggered for interaction in a plurality of interaction channels, and wherein the plurality of interaction channels has respective message presentation modes and support respective computer languages.

In some embodiments, presenting the reply message of the digital assistant for the conversation message includes: determining, from the plurality of interaction channels, the interaction channel in which the conversation message is received; and presenting, in the interaction channel, the reply message of the digital assistant for the conversation message based on the first message presentation mode corresponding to the determined interaction channel.

In some embodiments, the respective message presentation modes of the plurality of interaction channels are determined based on respective CUI capabilities of the plurality of interaction channels.

In some embodiments, the processing result indicates presenting the target content in a target data statistical form, and presenting the reply message of the digital assistant for the conversation message in the interaction channel includes: determining, in the first message presentation mode, a presentation style predefined for the target data statistical form; and presenting the target content in the reply message according to the presentation style.

In some embodiments, the target data statistical form includes at least one of the following: a chart type, or a form type.

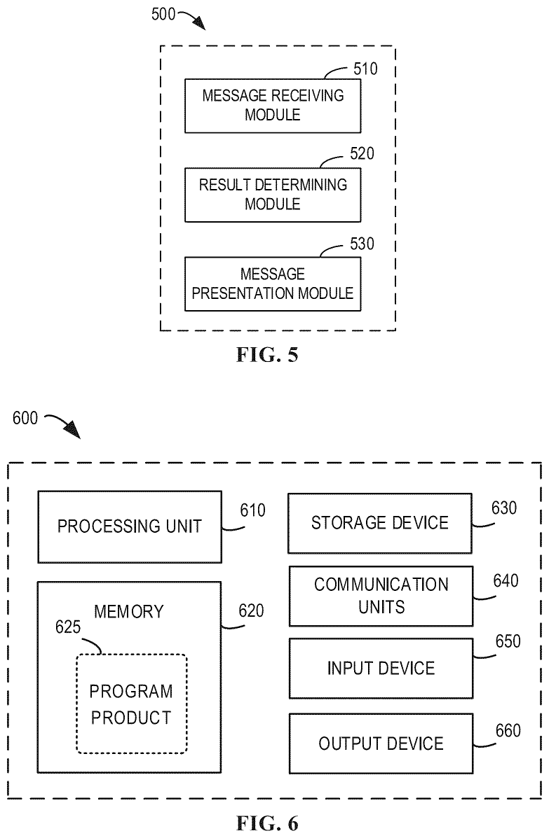

FIG. 5 illustrates a schematic structural block diagram of an apparatus for message processing according to some embodiments of the present disclosure. The apparatus 500 may be implemented, for example, in or included in the application running platform 140. Various modules/components in the apparatus 500 may be implemented by hardware, software, firmware, or any combination thereof.

As shown in the figure, the apparatus 500 includes a message receiving module 510 configured to receive, in an interaction between a user and a digital assistant, a conversation message of the user for the digital assistant.

The apparatus 500 further includes a result determining module 520 configured to determine a processing result for the conversation message by a model, the processing result indicating target content matching a user requirement corresponding to the conversation message. The apparatus 500 further includes a message presentation module 530 configured to present, based on a first message presentation mode corresponding to an interaction channel in which the conversation message is received, a reply message of the digital assistant for the conversation message in the interaction channel, the reply message presenting at least a portion of the target content.

In some embodiments, the processing result is represented in a second computer language, and wherein the message presentation module 530 is further configured to: determine a first computer language supported by the interaction channel based on the first message presentation mode; convert the processing result from the second computer language to description information in the first computer language; and present the reply message based on the description information.

In some embodiments, the model is trained based on the second computer language.

In some embodiments, the second computer language includes a markup language.

In some embodiments, the digital assistant is capable of being triggered for interaction in a plurality of interaction channels, and wherein the plurality of interaction channels has respective message presentation modes and support respective computer languages.

In some embodiments, the message presentation module 530 is further configured to: determine, from the plurality of interaction channels, the interaction channel in which the conversation message is received; and present, in the interaction channel, the reply message of the digital assistant for the conversation message based on the first message presentation mode corresponding to the determined interaction channel.

In some embodiments, the respective message presentation modes of the plurality of interaction channels are determined based on respective conversational user interface (CUI) capabilities of the plurality of interaction channels.

In some embodiments, the processing result indicates presenting the target content in a target data statistical form, and the message presentation module 530 is further configured to: determine, in the first message presentation mode, a presentation style predefined for the target data statistical form; and present the target content in the reply message according to the presentation style.

In some embodiments, the target data statistical form includes at least one of the following: a chart type, or a form type.

FIG. 6 illustrates a block diagram of an electronic device 600 in which one or more embodiments of the present disclosure may be implemented. It should be understood that the electronic device 600 in FIG. 6 is shown for merely illustrative purpose, and should not limit the functionality and scope of the embodiments described herein. The electronic device 600 shown in FIG. 6 may include or be implemented as the application running platform 140 in FIG. 1, or the apparatus 500 shown in FIG. 5.

As shown in FIG. 6, the electronic device 600 is in the form of a general-purpose computing device. Components of the electronic device 600 may include, but are not limited to, one or more processors or processing units 610, a memory 620, a storage device 630, one or more communications units 640, one or more input devices 650, and one or more output devices 660. The processing unit 610 may be a physical or virtual processor and can perform various processing according to a program stored in the memory 620. In a multiprocessor system, a plurality of processing units executes computer executable instructions in parallel, so as to improve the parallel processing capability of the electronic device 600.

The electronic device 600 typically includes a plurality of computer storage medium. Such media may be any available media that are accessible by the electronic device 600, including, but not limited to, volatile and non-volatile media, removable and non-removable media. The memory 620 may be a volatile memory (e.g., a register, cache, random access memory (RAM)), non-volatile memory (e.g., read-only memory (ROM), electrically erasable programmable read-only memory (EEPROM), flash memory), or some combination thereof. The storage device 630 may be a removable or non-removable medium and may include a machine-readable medium, such as a flash drive, a magnetic disk, or any other medium that can be used to store information and/or data and that can be accessed within the electronic device 600.

The electronic device 600 may further include additional detachable/undetachable, volatile/nonvolatile storage medium. Although not shown in FIG. 6, a magnetic disk drive for reading from or writing to a detachable, nonvolatile magnetic disk, such as a “floppy disk” and an optical disk drive for reading from or writing to a detachable, nonvolatile optical disk may be provided. In these cases, each drive may be connected to a bus (not shown) by one or more data media interfaces. The memory 620 may include a computer program product 625 having one or more program modules configured to perform various methods or actions of various embodiments of the present disclosure.

The communication unit 640 implements communication with other electronic devices through a communication medium. Additionally, functions of components of the electronic device 600 may be implemented by a single computing cluster or a plurality of computing machines, and these computing machines can communicate through a communication connection. Thus, the electronic device 600 may operate in a networked environment using logical connections to one or more other servers, network personal computers (PCs), or another network node.

The input device 650 may be one or more input devices, such as a mouse, a keyboard, a trackball, etc. The output device 660 may be one or more output devices, such as a display, a speaker, a printer, etc. The electronic device 600 may also communicate with one or more external devices (not shown), such as a storage device, a display device, or the like through the communication unit 640 as desired, and communicate with one or more devices that enable a user to interact with the electronic device 600, or communicate with any device (e.g., a network card, a modem, or the like) that enables the electronic device 600 to communicate with one or more other electronic devices. Such communication may be performed via an input/output (I/O) interface (not shown).

According to an example implementation of the present disclosure, a computer readable storage medium is provided, on which computer-executable instructions are stored, wherein the computer-executable instructions are executed by a processor to implement the method described above. According to an example implementation of the present disclosure, a computer program product is further provided, which is tangibly stored on a non-transitory computer readable medium and includes computer-executable instructions that are executed by a processor to implement the method described above.

Aspects of the present disclosure are described herein with reference to flowcharts and/or block diagrams of methods, apparatus, devices and computer program products implemented in accordance with the present disclosure. It should be understood that each block of the flowcharts and/or block diagrams and combinations of blocks in the flowchart and/or block diagrams can be implemented by computer readable program instructions.

These computer readable program instructions may be provided to a processing unit of a general-purpose computer, special purpose computer, or other programmable data processing apparatus to produce a machine, such that the instructions, when executed via the processing unit of the computer or other programmable data processing apparatus, create means for implementing the functions/actions specified in one or more blocks of the flowcharts and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture that includes instructions which implement various aspects of the functions/actions specified in one or more blocks of the flowcharts and/or block diagrams.

The computer readable program instructions may be loaded onto a computer, other programmable data processing apparatus, or other devices, causing a series of operational steps to be performed on the computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods and computer program products according to various implementations of the present disclosure. In this regard, each block in the flowchart or block diagram may represent a module, segment, or portion of instructions which includes one or more executable instructions for implementing the specified logical function(s). In some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the present disclosure have been described as above, the foregoing description is illustrative, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein.

I/We claim:

1. A method for message processing, comprising:
receiving, in an interaction between a user and a digital assistant, a conversation message of the user for the digital assistant;
determining a processing result for the conversation message by a model, the processing result indicating target content matching a user requirement corresponding to the conversation message; and
presenting, based on a first message presentation mode corresponding to an interaction channel in which the conversation message is received, a reply message of the digital assistant for the conversation message in the interaction channel, the reply message presenting at least a portion of the target content.

2. The method of claim 1, wherein the processing result is represented in a second computer language, and wherein presenting the reply message for the digital assistant for the conversation message comprises:
determining a first computer language supported by the interaction channel based on the first message presentation mode;
converting the processing result from the second computer language to description information in the first computer language; and
presenting the reply message based on the description information.

3. The method of claim 2, wherein the model is trained based on the second computer language.

4. The method of claim 2, wherein the second computer language comprises a markup language.

5. The method of claim 1, wherein the digital assistant is capable of being triggered for interaction in a plurality of interaction channels, and wherein the plurality of interaction channels has respective message presentation modes and support respective computer languages.

6. The method of claim 5, wherein presenting the reply message of the digital assistant for the conversation message comprises:
determining, from the plurality of interaction channels, the interaction channel in which the conversation message is received; and
presenting, in the interaction channel, the reply message of the digital assistant for the conversation message based on the first message presentation mode corresponding to the determined interaction channel.

7. The method of claim 1, wherein the respective message presentation modes of the plurality of interaction channels are determined based on respective conversational user interface, CUI, capabilities of the plurality of interaction channels.

8. The method of claim 1, wherein the processing result indicates presenting the target content in a target data statistical form, and presenting the reply message of the digital assistant for the conversation message in the interaction channel comprises:
determining, in the first message presentation mode, a presentation style predefined for the target data statistical form; and
presenting the target content in the reply message according to the presentation style.

9. The method of claim 8, wherein the target data statistical form comprises at least one of the following:
a chart type, or
a form type.

10. An electronic device comprising:
at least one processing unit; and
at least one memory coupled to the at least one processing unit and storing instructions for execution by the at least one processing unit, the instructions, when executed by the at least one processing unit, causing the electronic device to perform acts comprising:
receiving, in an interaction between a user and a digital assistant, a conversation message of the user for the digital assistant;
determining a processing result for the conversation message by a model, the processing result indicating target content matching a user requirement corresponding to the conversation message; and
presenting, based on a first message presentation mode corresponding to an interaction channel in which the conversation message is received, a reply message of the digital assistant for the conversation message in the interaction channel, the reply message presenting at least a portion of the target content.

11. The electronic device of claim 10, wherein the processing result is represented in a second computer language, and wherein presenting the reply message for the digital assistant for the conversation message comprises:
determining a first computer language supported by the interaction channel based on the first message presentation mode;
converting the processing result from the second computer language to description information in the first computer language; and
presenting the reply message based on the description information.

12. The electronic device of claim 11, wherein the model is trained based on the second computer language.

13. The electronic device of claim 11, wherein the second computer language comprises a markup language.

14. The electronic device of claim 10, wherein the digital assistant is capable of being triggered for interaction in a plurality of interaction channels, and wherein the plurality of interaction channels has respective message presentation modes and support respective computer languages.

15. The electronic device of claim 14, wherein presenting the reply message of the digital assistant for the conversation message comprises:
determining, from the plurality of interaction channels, the interaction channel in which the conversation message is received; and
presenting, in the interaction channel, the reply message of the digital assistant for the conversation message based on the first message presentation mode corresponding to the determined interaction channel.

16. The electronic device of claim 10, wherein the respective message presentation modes of the plurality of interaction channels are determined based on respective conversational user interface, CUI, capabilities of the plurality of interaction channels.

17. The electronic device of claim 10, wherein the processing result indicates presenting the target content in a target data statistical form, and presenting the reply message of the digital assistant for the conversation message in the interaction channel comprises:
determining, in the first message presentation mode, a presentation style predefined for the target data statistical form; and
presenting the target content in the reply message according to the presentation style.

18. The electronic device of claim 17, wherein the target data statistical form comprises at least one of the following:
a chart type, or
a form type.

19. A non-transitory computer-readable storage medium having a computer program stored thereon, the computer program being executable by a processor to implement acts comprising:
receiving, in an interaction between a user and a digital assistant, a conversation message of the user for the digital assistant;
determining a processing result for the conversation message by a model, the processing result indicating target content matching a user requirement corresponding to the conversation message; and
presenting, based on a first message presentation mode corresponding to an interaction channel in which the conversation message is received, a reply message of the digital assistant for the conversation message in the interaction channel, the reply message presenting at least a portion of the target content.

20. The non-transitory computer-readable storage medium of claim 19, wherein the processing result is represented in a second computer language, and wherein presenting the reply message for the digital assistant for the conversation message comprises:
determining a first computer language supported by the interaction channel based on the first message presentation mode;
converting the processing result from the second computer language to description information in the first computer language; and
presenting the reply message based on the description information.
